(19) United States
(12) Patent Application Publication
(10) Pub. No.: US 2021/0320318 A1
(43) Pub. Date: Oct. 14, 2021

(54) MODULAR AND COMPACT IMPLANTATION OF BATTERY MODULES IN A CONTAINER

(71) Applicant: SAFT, Levallois-Perret (FR)

(72) Inventors: Philippe LAFLAQUIERE, SAINT CAPRAIS DE BORDEAUX (FR); James MCDOWALL, WALLINGFORD, CT (US); Alexandre NARBONNE, BLANQUEFORT (FR)

(73) Assignee: SAFT, Levallois-Perret (FR)

(21) Appl. No.: 17/267,571

(22) PCT Filed: Jul. 30, 2019
(86) PCT No.: PCT/EP2019/070548

§ 371 Date: Feb. 10, 2021

(30) Foreign Application Priority Data
Aug. 13, 2018 (FR) 1857471

(51) Int. Cl. H01M 10/04; H01M 50/209

(52) U.S. Cl. CPC H01M 10/0472; H01M 50/209; H01M 10/0486; H01M 10/0413

(57) ABSTRACT

The invention relates to a method for installing battery modules in a container in such a way as to maximize the amount of energy installed, while providing modularity of the voltage delivered by the container. The invention also relates to a method for installing electrochemical elements of parallelepipedal format in a volume of parallelepipedal format, such as a module or a vertical volume of a container.

### FIELD OF THE INVENTION

The invention relates to transport containers and transportable prefabricated shelters used as storage facilities for battery modules with a view to using such battery modules as a backup power source, for example for electrical/electronic equipment in the field of telecommunications.

### BACKGROUND ART

A battery module, sometimes referred to simply as a “module” in what follows is known from the prior art. It generally comprises a plurality of electrochemical cells, also simply called cells, electrically connected to each other, in series or in parallel, by means of metal bars. The module also generally comprises an electronic circuit for monitoring and managing the cells for measuring their state of charge and/or their state of health, in particular by means of voltage or current measurements taken individually cell-by-cell or taken at a group of cells. The module may also include a device for controlling the temperature of the cells.

A plurality of battery modules may be installed in a rack. A rack equipped with these modules forms a self-contained power source that can be moved and installed in proximity to electronic systems that will be powered by these modules in the event of mains or utility power outage. A plurality of racks may be associated to provide a greater amount of energy to the electronic system. The racks may be grouped into a container that can be placed on the chassis of a transportation means, such as a goods train or a boat, to be transported to a given location. In the field of transport, a container is a box-shaped metal box designed for the transport of goods by different modes of transport, such as maritime transport. Its dimensions have been normalized at international level.

EP-A-2,506,337 discloses a container of standardized dimensions according to the ISO standard, comprising a plurality of racks, each rack being intended to contain battery modules, each rack comprising an insertion face of these modules, the container being characterized in that half at least of the racks is arranged such that the insertion face of the modules is perpendicular to the direction defined by the length of the container.

Battery modules are currently installed in a container by vertically stacking the modules. Thus, columns of modules are formed. The columns of modules are electrically connected together until the desired voltage is reached to power an electronic system, such as a converter.

Converters may operate under a relatively wide range of voltages, typically from 850V to 1500V. However, the limited height of the container limits the number of modules that can be stacked in a column and thus the voltage that the column can deliver. If it is desired to increase the voltage, it is necessary to continue stacking modules on an adjacent column and serially connect the two adjacent columns. According to the desired voltages, branches are created consisting of columns of modules connected in series, completed to varying degrees as regards their height, thereby generating empty locations that penalize the amount of energy on board the container.

FIG. 1 illustrates a first configuration, Conf 1, showing 8 battery modules (m1 to m8) stacked to form a column C1. These 8 battery modules are connected in series to output a voltage V1. It is noted that this configuration 1 makes it possible to fill the entire height of the container. On the other hand, the Conf 2 configuration showing a first column C2 consisting of 8 modules (m1 to m8) and a second adjacent column C3 comprising 3 modules (m9 to ml1) to obtain a voltage V₂, has a lower fill rate. Indeed, column C3 comprises an unoccupied space corresponding to the volume of 5 modules.

In addition, continuing the stack from one column to another adjacent column renders electrical wiring and locating parallel branches relatively complex. Mounting and maintenance phases then become hazardous to an operator. Such a situation is illustrated in the Conf 3 configuration of FIG. 1. Column C5 comprises 3 modules m9 to ml11 which are connected in series with the 8 modules m1 to m8 of column C4. Column C5 also comprises 5 modules m1 to m5 which are connected in series with the 6 modules m6 to ml 1 of column C6. It will be noticed that there is within column C5, a first group of 3 modules m9 to ml 11 which, associated with the modules m1 to m8 of column C4, form a first branch, and a second group of 5 modules m1 to m5 which, associated with the 6 modules m6 to ml1 of column C6 form a second branch. Column C5 thus comprises modules which are part of two different branches. This makes the mounting and maintenance phases complex for an operator.

Thus, there is a need for a method to find the best arrangement of battery modules in a container or in any other enclosure, and to maximize installed energy, while maintaining modularity of the voltage delivered by the container, such modularity being necessary to meet the different voltage requirements of a user.

### SUMMARY OF THE INVENTION

To this end, the invention provides a method for installing a plurality of battery modules in an enclosure, the battery modules being capable of being stacked to form one or more columns and being capable of being connected in series within a same column, at least two adjacent columns being connectable in series, the set of battery modules being capable of outputting a voltage Vᵢ selected from a group of n values of voltages V₁, V₂ . . . , Vₙ, predetermined by a user, said method comprising the steps of:

a) determining a basic voltage U of a column of battery modules, said basic voltage U being such that U=Vᵢ/kᵢ−Eᵢ×Vᵢ; i ranging from 1 to n and kᵢ being an integer, Eᵢ ranging from 0 to Eₘₐₓ, Eₘₐₓ being set by the user;

b) determining the n series of multiple integers M_{(i,m)} of kᵢ, m being an integer up to 50;

c) selecting a group of n values taken in different series of the multiple integers M_{(i,m)} of kᵢ, so that the difference between the highest value of the group and the lowest value of the group is minimal;

d) selecting a number N of columns included in a range running from the lowest value of the group to the highest value of the group;

e) installing in the enclosure N columns each consisting of a stack of battery modules connected in series and delivering a voltage at least equal to the basic voltage U of the column;

f) performing series connection of the columns to allow non-simultaneous delivery of each of the voltages selected from V₁ . . . Vₙ.

In one embodiment, the enclosure is of length L and the method includes determining the width 1 of a column by dividing the length L of the enclosure by the number N of columns.

According to one embodiment, the method further comprises in step f), the series connection of the kᵢ columns constitutes a battery branch delivering a voltage Vᵢ equal to kᵢ×U.

According to one embodiment, the method further comprises a step g) of parallel connection of at least two battery branches.

According to one embodiment, the number N of columns is equal to the smallest common multiple of the n values kᵢ.

In one embodiment, the enclosure is a prefabricated shelter or a transport container whose dimensions are normalized.

The invention also relates to an enclosure comprising a plurality of battery modules, in which the battery modules are stacked, form N columns, and are connected in series within a same column, wherein two adjacent columns can be connected in series, the set of battery modules being capable of outputting a voltage Vᵢ selected from a group of n voltage values V₁, V₂ . . . , Vₙ, predetermined by a user, each column of battery modules delivering a basic voltage U, U being such that U=Vᵢ/kᵢ−Eᵢ×Vᵢ, i ranging from 1 to n and kᵢ being an integer, Eᵢ ranging from 0 to Eₘₐₓ, Eₘₐₓ being set by the user.

In one embodiment, the N columns have a same number of battery modules.

In one embodiment, there is no interruption of the serial connection between two battery modules within a same column.

The invention also provides a method for installing a plurality of electrochemical cells of parallelepiped format in a volume of parallelepiped format, each electrochemical cell having six different orientations in the volume, the method comprising the steps of:

a) determining the maximum number of electrochemical cells capable of being housed in the parallelepiped format volume according to each of the three directions of space, for each one of the six orientations;

b) calculating the fill rate of the volume for each of the six orientations from the maximum number of electrochemical cells determined in step a);

c) selecting by a user a minimum fill rate of the parallelepiped format volume;

d) selecting one or more orientations from the six possible orientations, for which the fill rate of the volume is at least equal to the minimum fill rate selected in step c).

According to one embodiment, the volume having a parallelepiped format is the inside volume of a battery module housing or a vertical volume of a room or container.

According to one embodiment, the volume having a parallelepiped format is a vertical volume of a room or of a container, and at each orientation adopted in step d), there corresponds a stack of a maximum number n₃ of layers each comprising one or more electrochemical cells.

In one embodiment, a plurality of layers each including one or more electrochemical cells are connected in series, and are capable of delivering a column basic voltage U.

According to one embodiment, the method further comprises a step e) of seeking among the orientations selected in step d) an arrangement of the electrochemical cells compatible with the voltage U, during which step e), the voltage T delivered by a layer comprising one or more electrochemical cells is determined, by dividing the column voltage U by the maximum number n₃ of layers.

According to one embodiment, a connection mode is determined as in series and/or in parallel of electrochemical cells located on a same layer in such a way that these cells deliver a voltage less than or equal to the voltage T.

In one embodiment, the one or more electrochemical cells of a same layer are grouped together to form a battery module.

The invention also provides a method comprising:
carrying out the steps of the method for installing a plurality of battery modules as described above, followed by
carrying out the steps of the method for installing a plurality of electrochemical cells of parallelepiped format in a volume of parallelepiped format as described above.

### BRIEF DESCRIPTION OF THE DRAWINGS

FIG. 1 shows three configurations of battery modules Conf 1, Conf 2 and Conf 3.

FIG. 2 represents the height (h), width (W) and thickness (e) dimensions of a parallelepiped-shaped cell.

FIG. 3 shows the six possible orientations A to F of a cell of parallelepiped format in a volume of parallelepiped format.

FIG. 4 shows a perspective view of a module of cells which can be subdivided into three sub-assemblies, each sub-assembly consisting of 22 cells connected in parallel, the three sub-assemblies being connected in series (known as a 22P3S) mounting.

### DETAILED DESCRIPTION OF EMBODIMENTS

The method according to the invention is broken down into two steps. In a first step, the best fill rate of the container is sought and in a second step, the best fill rate of a column by the cells is sought.

1 Determining the Configuration of the Modules to Obtain the Best Fill Rate of the Container

The description of the step of seeking the best fill rate is described in what follows with reference to a container but it can be generalized to any enclosure, to any room of a building, to any box intended for storage or transport of battery modules, it being understood that the enclosure, the part of a building and the box are of parallelepiped format.

The volume of the container is defined by its height H, its depth P and its largest horizontal dimension L. These dimensions can meet the requirements of ISO standard TC-104. The largest horizontal dimension can reach about 5 m. The inside volume of the container is intended to receive a plurality of columns each comprising a stack of a plurality of battery modules. Each module itself comprises an association of at least two cells connected in a series and/or a parallel configuration. The cells may be of any type, for example nickel-cadmium, nickel-metal hydride or lithium-ion.

The battery modules are typically housed in a rack that serves as a support for stacking modules within a same column. A column preferably occupies substantially all of the height of the container. A space is generally provided between two modules placed one on top of the other to allow cooling of these modules and the passage of electrical cables. A space is generally also provided above the module at the top of each column. The columns are juxtaposed along the largest horizontal dimension L of the container. The battery modules are connected to each other in series within a same column. The sum of the voltages of the battery modules stacked within a same column is the basic voltage U of the column.

Columns are connected in series by electrical connections. For ease of connection, an electrical connection connects two adjacent columns. The addition of the basic voltages of several columns resulting from the series connection of these columns makes it possible to obtain a predetermined voltage Vᵢ, chosen by a user. The assembly formed by the series connection of several columns constitutes a battery branch. A plurality of battery branches each delivering the voltage Vᵢ can be connected in parallel so as to increase the electrochemical capacity provided to the user.

A first sub-step of seeking the best fill rate of the container comprises determining the basic voltage U of a column.

A container equipped with battery modules is capable of delivering a voltage Vᵢ selected from a plurality of voltages V₁, V₂ . . . Vₙ. These n voltages V₁, V₂. . . Vₙ are defined beforehand before installation of the battery modules in the container. The user selects the voltage Vi that the container must deliver, without however exceeding it.

The basic voltage U of a column is determined as: U=Vᵢ/kᵢ−Eᵢ×Vᵢ; with i ranging from 1 to n and kᵢ being an integer, Eᵢ ranging from 0 to Eₘₐₓ, Eₘₐₓ being set by the user, and is as small as possible. Eₘₐₓ can be set to 5%, 2%, 1% or 0.5%. Eᵢ is defined as the percentage deviation from the ideal case where the basic voltage U of a column is an integer divisor of the desired voltage Vᵢ. The basic voltage U of a column is the same for all columns. The series connection of several columns makes it possible to reach the n voltages V₁, V₂ . . . Vₙ being sought.

Assuming that the user needs a container capable of outputting a voltage selected from the following 4 voltages: V₁=850 V; V₂=1100 V; V₃=1300 V and V₄=1500 V it is determined that a basic voltage U of 210 V makes it possible to approach the voltages sought by the series connection of several columns. The details of the calculations are made explicit in Table 1.

TABLE 1

| | Basic voltage U of the column | Vᵢ | kᵢ | Eᵢ |
|---|---|---|---|---|
| i = 1 | 210 = (850/4) − 10/4~(850/4) − 0.29% × 850 | 850 | 4 | 0.29% |
| i = 2 | 210 = (1100/5) − 50/5~(1100/5) − 0.9% × 1100 | 1100 | 5 | 0.9% |
| i = 3 | 210 = (1300/6) − 40/6~(1300/6) − 0.5% × 1300 | 1300 | 6 | 0.5% |
| i = 4 | 210 = (1500/7) − 30/7~(1500/7) − 0.29% × 1500 | 1500 | 7 | 0.29% |

The desired voltages of 850, 1100, 1300 and 1500 V can be approximated by connecting in series 4, 5, 6 and 7 columns each delivering a basic voltage of 210 V. Connection of the columns in series enables the non-simultaneous delivery of each of the voltages selected from 850, 1100, 1300 and 1500 V.

A second sub-step includes determining the number of columns to be installed in the container to obtain the best fill rate of the container, regardless of the n voltage values. This second sub-step comprises determining the n series of multiple integers M_{(i,m)} of kᵢ. The value of m is limited due to the limited horizontal dimension of the container. For example, m ranges from 1 to 50, or is from 1 to 25, or is from 1 to 15. Table 2 indicates the values of the integer multiples M_{(i,m)} of the values of kᵢ, i ranging from 1 to 4 and m ranging from 1 to 13.

TABLE 2

| | Voltage configuration (4 columns to 7 columns) | | | |
|---|---|---|---|---|
| | k₁ = 4 | k₂ = 5 | k₃ = 6 | k₄ = 7 |
| | (4 columns | (5 columns | (6 columns | (7 columns |
| kᵢ | in series) | in series) | in series) | in series) |
| Vi | V₁ = 850 V | V₂ = 1100 V | V₃ = 1300 V | V₄ = 1500 V |
| M_{(i,m)} | M_{(1,1)} = 4 | M_{(2,1)} = 5 | M_{(3,1)} = 6 | M_{(4,1)} = 7 |
| (number | M_{(1,2)} = 8 | M_{(2,2)} = 10 | M_{(3,2)} = 12 | M_{(4,2)} = 14 |
| of | M_{(1,3)} = 12 | M_{(2,3)} = 15 | M_{(3,3)} = 18 | M_{(4,3)} = 21 |
| branches) | M_{(1,4)} = 16 | M_{(2,4)} = 20 | M_{(3,4)} = 24 | M_{(4,4)} = 28 |
| | M_{(1,5)} = 20 | M_{(2,5)} = 25 | M_{(3,5)} = 30 | M_{(4,5)} = 35 |
| | M_{(1,6)} = 24 | M_{(2,6)} = 30 | M_{(3,6)} = 36 | M_{(4,6)} = 42 |
| | M_{(1,7)} = 28 | M_{(2,7)} = 35 | M_{(3,7)} = 42 | M_{(4,7)} = 49 |
| | M_{(1,8)} = 32 | M_{(2,8)} = 40 | M_{(3,8)} = 48 | M_{(4,8)} = 56 |
| | M_{(1,9)} = 36 | M_{(2,9)} = 45 | M_{(3,9)} = 54 | M_{(4,9)} = 63 |
| | M_{(1,10)} = 40 | M_{(2,10)} = 50 | M_{(3,10)} = 60 | M_{(4,10)} = 70 |
| | M_{(1,11)} = 44 | M_{(2,11)} = 55 | M_{(3,11)} = 66 | M_{(4,11)} = 77 |
| | M_{(1,12)} = 48 | M_{(2,12)} = 60 | M_{(3,12)} = 72 | M_{(4,12)} = 84 |
| | M_{(1,13)} = 52 | M_{(2,12)} = 65 | M_{(3,13)} = 78 | M_{(4,13)} = 91 |

In the established n series of multiples, a group of n multiples taken in different series is selected so that the difference between the highest value of the group and the lowest value of the group is minimal. The lower the difference between the highest value of the group and the lowest value of the group, the better is the fill rate of the container. In a preferred embodiment, this difference is zero, that is, the values of the n multiples are the same and correspond to the smallest common multiple of the values of kᵢ, i ranging from 1 to n.

The number N of columns to be installed in the container is selected in a range from the lowest value of the group to the highest value of the group.

In one embodiment, the number N of columns is equal to the highest value of the group.

In the preferred embodiment, the number n of columns to be installed corresponds to the smallest common multiple of the values of kᵢ, i ranging from 1 to n.

The columns per group of kᵢ columns are then connected in series, i ranging from 1 to n, as a function of the desired voltage Vᵢ. Each group of kᵢ columns constitutes a battery branch. A plurality of battery branches can be connected in parallel. If the number of columns remaining available is less than the number kᵢ of columns necessary to obtain the desired voltage Vᵢ, then these columns are not connected. The presence of non-connected columns reduces the occupancy rate of the container.

In the example of table 2, the group of the 4 multiples taken in different series consists of M_{(1,9)}=36; M_{(2,7)}=35; M_{(3,6)}=36 and M_{(4,5)}=35. The number of columns N to be installed in the container may be 35 or 36.

In the case where 35 columns are installed, the following four configurations which are mutually exclusive can be obtained:

8 branches each consisting of 4 columns, each branch delivering 850 V, and 3 unused columns, or

7 branches each consisting of 5 columns, each branch delivering 1100 V, or

5 branches each consisting of 6 columns delivering 1300 V and 5 unused columns or

5 branches each consisting of 7 columns delivering 1500 V.

The occupancy rate of the container is 100% for the 1100 and 1500 V configurations. It is 32/35x 100 or 91% for the 850 V configuration and 30/35x 100 or 85% for the 1300 V configuration.

In the case where 36 columns are installed, the following four configurations which are mutually exclusive can be obtained:

9 branches each consisting of 4 columns, each branch delivering 850 V or

7 branches each consisting of 5 columns, each branch delivering 1100 V and a non-connected column, or

6 branches each consisting of 6 columns delivering 1300 V or

5 branches each consisting of 7 columns delivering 1500 V and a non-connected column.

The occupancy rate of the container is 100% for the 850 and 1300 V configurations. It is 35/36x100 or 97% for the 1100 and 1500 V configurations.

The average occupancy rate in the configuration consisting of 36 columns is greater than that in the configuration consisting of 35 columns. It is therefore preferable in this example to install 36 columns rather than 35.

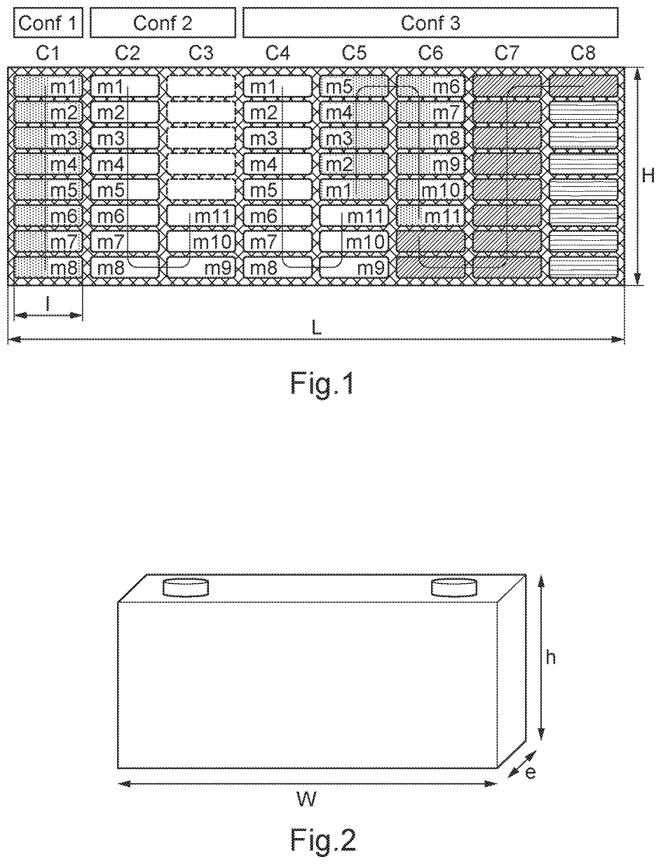

The invention enables modular implantation of the battery modules. The modularity is the possibility for the user to choose an operating voltage Vᵢ of the container from several voltages. V₁, V₂ . . . Vₙ that the container is able to deliver. The user may, by simply changing the wiring of the serial connections between the columns, modify the voltage delivered by the container. The modification of the wiring is easy for the user in view of the fact that all the columns provide a same basic voltage U and each of the voltages Vᵢ that the container is able to deliver is an integral multiple of the basic voltage U of a column. The configuration 2 of FIG. 1, in which some modules of a column are connected in series with each other while the other modules of the column are not connected in series with each other, is therefore avoided. Configuration 3 of FIG. 1, in which some modules of a column are connected to each other in series to form part of a branch delivering a voltage Vᵢ while the other modules of a same column are connected together to form part of another branch delivering a voltage V_{i′}, V_{i′}, which may be equal to or not to is also avoided. The invention thus makes it possible to make the assembly and maintenance operations of the modules safer.

The invention makes it possible to increase the compactness of the battery modules because each column comprises a same number of battery modules. There is no column which is partially filled with battery modules, since each column delivers a same basic voltage, therefore the configuration of FIG. 2 is avoided, in which a column comprises empty locations, which penalizes the energy on board the container.

In a third sub-step, the dimensions of the column are determined. The width 1 of a column is obtained by dividing the length L of the container by the number N of columns, obtained by applying the method as described above. The height H is imposed by the choice of the container. The depth of the column is fixed by the width of the container, reserving space for cooling and the supporting structure of the modules.

The dimensions of a column is therefore available at the end of this first step. Knowledge of these dimensions is used in a second step of the method for seeking the arrangement of the cells in the column to achieve the best fill rate of the column by the cells.

2) Seeking the Best Fill Rate of the Column by the Cells

In a first sub-step, orientation (or orientations) of the cells that allow a maximum fill rate of the column is (or are) determined. Account is taken of the fact that the cells are of parallelepiped format and that these cells fill a column volume that is also of parallelepiped format. These cells are grouped into a module. The best arrangement of the different cells within a same module is obtained in a second sub-step.

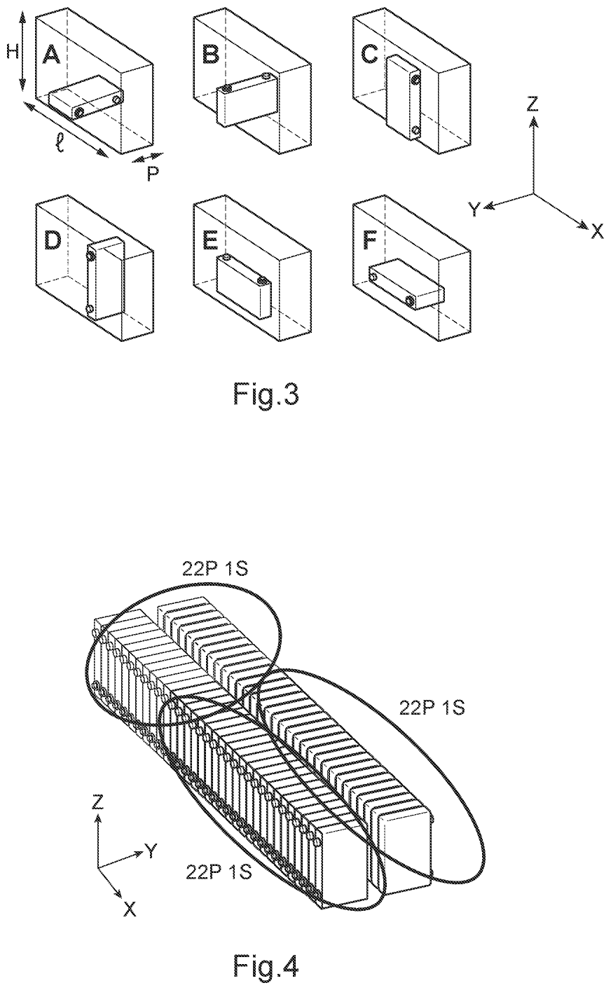

Each cell can be likened to a parallelepiped of height h, width W and thickness e as shown in FIG. 2. It has six different orientations in the column volume. These six orientations are shown schematically in FIG. 3 and are denoted A to F.

Seeking the best fill rate includes calculating the number of cells receivable in the column volume for each of the six possible orientations. This calculation is carried out taking into account the clearance required for mounting the battery modules and other technical constraints, in particular the possibility of providing a space around the modules in order to ensure their cooling. This clearance is included in the dimensions h, W and e of the cell used in the remainder of the calculation.

For each of the six orientations A to F, the following are calculated:

the number of cells n₁ that can be juxtaposed in the width direction 1 of the column. This direction is indicated by the X-axis of FIG. 3.

the number of cells n₂ can be juxtaposed in the direction of the depth P of the column. This direction is indicated by the Y-axis of FIG. 3.

the number of cells may be juxtaposed (or stacked) in the height direction H of the column. This direction is indicated by the Z-axis of FIG. 3.

For example for orientation A, the value nᵢ is obtained by dividing the width 1 of the column by the height H of the cell. The value n₂ is obtained by dividing the depth P of the column by the width W of the cell. The value n₃ is obtained by dividing the height h of the column by the thickness e of the cell. The values n₁, n₂ and n₃ obtained are rounded down to the lower integer. The maximum number of cells that can be accommodated in the volume of a column corresponds to the product of the values n₁, n₂ and n₃. To this maximum number of cells that can be juxtaposed in the three directions of space there corresponds a volume. This volume is calculated and divided by the volume of a column to obtain a fill rate. Each of the six orientations A to F corresponds to a fill rate. Each fill rate is compared to a predetermined threshold value by the user.

Only those orientations for which the fill rate is greater than the predetermined threshold value are retained. The fill rate selected by the user is preferably greater than 75%, more preferably greater than 90%, and even more preferably greater than 95%.

The principle of calculating the fill rate is illustrated in an example in which the cell has a width W of 148 mm, a thickness e of 26.5 mm and a height h of 91 mm. The column has a depth P of 260 mm, a height of 2300 mm and a width 1 of 945 mm. The width, depth and height of the column respectively extend along the X, Y and Z axes of FIG. 3.

TABLE 3

| | Number n₁ | Number n2 | Number n3 | |
|---|---|---|---|---|
| | of cells | of cells | of cells | |
| | able to be | able to be | able to be | |
| | juxtaposed | juxtaposed | juxtaposed | Fill rate of |
| Orientation | in the X | in the Y | in the Z | column by |
| of cell | direction | direction | direction | the cells |
| A | 9.09 | 1.72 | 80.70 | [symbol] |
| B | 1.72 | 33.16 | 22.12 | [symbol] |
| C | 9.09 | 9.12 | 15.23 | 96% |
| D | 33.16 | 2.50 | 15.23 | 78% |
| E | 6.26 | 9.12 | 22.12 | 94% |
| F | 6.26 | 2.50 | 80.70 | 76% |

Table 3 indicates the fill rate for each of the orientations A to F of the cells in the column. This calculation is carried out taking into account the clearance required for mounting the battery modules. With a threshold of 75% of the fill rate, the orientations making it possible to obtain a high fill rate are the orientations C, D, E and F

The method has been described in the case of finding the best orientation of cells in a container column but can be applied to the determination of the orientation of cells in the housing of a module, like as in any other volume of parallelepiped format.

In a second sub-step, the series/parallel connection mode of the cells is determined which is compatible firstly with the column voltage U determined in the first step of the method and secondly with the electrochemical capacity desired by the user of the container.

The basic voltage U of a column is obtained by adding the voltages outputted from each of the modules connected in series. The number of modules stacked in the height direction of the container is the number n₃ of modules. Each module constitutes a layer of the vertical stack of modules. By dividing the basic voltage U of the column by the number n₃ rounded down to the lower integer, the voltage T to be supplied to a module is determined. Knowing the number of cells in a module which is the product of nᵢ rounded down to the integer below and n₂ rounded down to the lower integer, the connection mode of the cells within the module is deduced therefrom.

The principle of the determination of the serial/parallel connection mode is shown below by taking the numerical values from table 3. For the orientations C, D, E and F adopted, the maximum number n₃ of stacked modules rounded to the lower integer is respectively 15, 15, 22 and 80. The voltage T to be supplied to a module is therefore U/(n₃ rounded to the lower integer), or 14 V, 14 V, 9.54 V and 2.63 V for orientations C, D, E and F, respectively. Each module comprises a number of cells equal to (n₁ rounded to the lower integer)×(n₂ rounded to the lower integer), either 81, 66, 54 and 12 cells for the orientations C, D, E and F respectively. In the case of lithium ion cells having a nominal voltage of 4 V, it is determined that:

for orientation C, the 81 cells of the module can be connected in a 27P3S arrangement, i.e. consisting of 3 sub-groups of cells connected in series, each subgroup consisting of 27 cells connected in parallel.

for orientation D, the 66 cells of the module can be connected in a 22P3S arrangement, i.e. consisting of 3 sub-groups of cells connected in series, each sub-group consisting of 22 cells connected in parallel. This arrangement is illustrated in FIG. 4

for orientation E, the 54 cells of the module can be connected according to an 18P3S arrangement, i.e. consisting of 3 sub-groups of cells connected in series, each subgroup consisting of 18 cells connected in parallel.

for orientation F, the 12 cells of the module can be connected in parallel.

Among the four orientations C, D, E and F, the one(s) is/are adopted which make it possible to come close to the voltage T which is to be supplied to a module, but not to exceed it. In the example:

the arrangement 27P3S of orientation C corresponds to a module voltage of 12 V, which is less than the desired voltage T of 14 V. The arrangement of orientation C is therefore adopted.

the arrangement 22P3S of orientation D corresponds to a module voltage of 12 V, which is less than the desired voltage T of 14 V. The arrangement of orientation D is therefore adopted.

the arrangement 18P3S of orientation E corresponds to a module voltage of 12 V, which is greater than the desired voltage T of 9.54 V. The arrangement of orientation E is therefore eliminated.

The arrangement of orientation F corresponds to a module voltage of 4 V, which is greater than the desired voltage T of 2.63 V. The arrangement of orientation F Is therefore eliminated.

Finally, in a third sub-step, the adopted orientations are preferably sorted according to the criterion of ease of production. The ease of access to the terminals of the cells is mainly considered by an operator. In this regard, orientation D allows easy access to the terminals of the cells, unlike orientation C. The orientation of the cells according to orientation D could be adopted instead of orientation C, although having a lesser fill rate (78 instead of 96%).

In conclusion, the method according to the invention makes it possible to increase the energy density of containers in which battery modules are installed. The fact of being able to pack a maximum of energy into a container makes it possible to reduce operating cost per kWh.

1. A method of installing a plurality of battery modules in an enclosure, the battery modules being capable of being stacked to form one or more columns and being capable of being connected in series within a same column, at least two adjacent columns being connectable in series, a set of battery modules being capable of outputting a voltage Vᵢ selected from a group of n values of voltages V₁, V₂ . . . Vₙ, predetermined by a user, said method comprising the steps of:
a) determining a basic voltage U of a column of battery modules, said basic voltage U being such that U=Vᵢ/kᵢ−Eᵢ×Vᵢ; with i ranging from 1 to n and kᵢ being an integer, Eᵢ ranging from 0 to Eₘₐₓ, Eₘₐₓ being set by the user;
b) determining the n series of multiple integers M_{(i,m)} of kᵢ, m being an integer up to 50;
c) selecting a group of n values taken in different series of the multiple integers M_{(i,m)} of kᵢ, so that the difference between the highest value of the group and the lowest value of the group is minimal;
d) selecting a number N of columns included in a range from the lowest value of the group to the highest value of the group;
e) installing in the enclosure N columns each consisting of a stack of battery modules connected in series and delivering a voltage at least equal to the basic voltage U of the column;
f) performing series connection of the columns to allow non-simultaneous delivery of each of the voltages selected from V₁ . . . Vₙ.

2. The method of claim 1, wherein the enclosure is of length L and the method comprises determining the width 1 of a column by dividing the length L of the enclosure by the number N of columns.

3. The method according to claim 1, wherein, in step f), the series connection of the kᵢ columns constitutes a battery branch delivering a voltage Vᵢ equal to kᵢ x U.

4. The method of claim 3, further comprising a step g) of parallel connection of at least two battery branches.

5. The method according to claim 1, in which the number N of columns is equal to the smallest common multiple of the n values kᵢ.

6. The method according to claim 1, wherein the enclosure is a prefabricated shelter or a transport container whose dimensions are normalized.

7. An enclosure comprising a plurality of battery modules, wherein the battery modules are stacked, form N columns, and are connected in series within a same column, wherein two adjacent columns can be connected in series, the set of battery modules being capable of outputting a voltage Vᵢ selected from a group of n voltage values V₁, V₂ . . . , Vₙ, predetermined by a user, each column of basic modules delivering a basic voltage U, U being such that U=Vᵢ/kᵢ−Eᵢ×Vᵢ; i ranging from 1 to n and kᵢ being an integer, Eᵢ ranging from 0 to Eₘₐₓ, Eₘₐₓ being set by the user.

8. The enclosure of claim 7, wherein the N columns have a same number of battery modules.

9. The enclosure according to claim 7, in which there is no interruption of a series connection between two battery modules within a same column.

10. A method for installing a plurality of electrochemical cells of parallelepiped format in a volume of parallelepiped format, each electrochemical cell having six different orientations in the volume, the method comprising the steps of:
a) determining a maximum number of electrochemical cells capable of being housed in the parallelepiped format volume according to each of the three directions of space, for each of the six orientations;
b) calculating the fill rate of the volume for each of the six orientations from the maximum number of electrochemical cells determined in step a);
c) selecting by a user a minimum fill rate of the parallelepiped format volume;
d) selecting one or more orientations from the six possible orientations, for which the fill rate of the volume is at least equal to the minimum fill rate selected in step c).

11. The method of claim 10, wherein the parallelepiped format volume is the inside volume of a battery module housing or a vertical volume of a room or container.

12. The method according to claim 10, wherein the parallelepiped format volume is a vertical volume of a room or container, and at each orientation adopted in step d), there corresponds a stack of a maximum number n₃ of layers each comprising one or more electrochemical cells.

13. The method of claim 12, wherein a plurality of layers each comprising one or more electrochemical cells are connected in series, and are capable of delivering a column basic voltage U.

14. The method according to claim 13, further comprising a step e) of seeking among the orientations selected in step d) an arrangement of the electrochemical cells compatible with voltage U, during which step e), the voltage T delivered by a layer comprising one or more electrochemical cells is determined, by dividing the column voltage U by the maximum number n₃ of layers.

15. The method according to claim 14, wherein the series and/or parallel connection mode of the electrochemical cells located on a same layer is determined in such a way that said cells deliver a voltage less than or equal to the voltage T

16. The method according to claim 12, wherein the one or more electrochemical cells of a same layer are grouped together to form a battery module.

17. A method comprising:
carrying out the steps of the method for installing a plurality of battery modules according to claim 1, followed by
carrying out the steps of the method for installing a plurality of electrochemical cells of parallelepiped format in a volume of parallelepiped format, comprising:
a) determining a maximum number of electrochemical cells capable of being housed in the parallelepiped format volume according to each of the three directions of space, for each of the six orientations;
b) calculating the fill rate of the volume for each of the six orientations from the maximum number of electrochemical cells determined in step a);
c) selecting by a user a minimum fill rate of the parallelepiped format volume;
d) selecting one or more orientations from the six possible orientations, for which the fill rate of the volume is at least equal to the minimum fill rate selected in step c).
